(19) United States
(12) Patent Application Publication
(10) Pub. No.: US 2015/0169433 A1
(43) Pub. Date: Jun. 18, 2015

(54) Automated Generation of Semantically Correct Test Data for Application Development

(71) Applicants: Rafi Bryl, Tel Aviv (IL); Rima Sirich, Netanya (IL)

(72) Inventors: Rafi Bryl, Tel Aviv (IL); Rima Sirich, Netanya (IL)

(21) Appl. No.: 14/560,866

(22) Filed: Dec. 4, 2014

Related U.S. Application Data
(60) Provisional application No. 61/915,378, filed on Dec. 12, 2013.

(51) Int. Cl. G06F 11/36

(52) U.S. Cl. CPC G06F 11/3684

(57) ABSTRACT

Methods, systems, and computer-readable storage media for selecting columns for generating test data for an application that is to be tested. Implementations include actions of receiving user input indicating an entity of the application, receiving a data structure of the entity, the data structure providing a set of elements of the entity, the set of elements including one or more elements, each element being associated with a value type, displaying the set of elements, each element being associated with a rule defining how values of the respective element are to be provided, and providing test data for elements of the set of elements based on respective rules, the test data including values that are semantically correct for a respective type.

### CROSS-REFERENCE TO RELATED APPLICATIONS

This application claims priority to U.S. Provisional App. No. 61/915,378 filed on Dec. 12, 2013, the disclosure of which is expressly incorporated herein by reference in its entirety.

### BACKGROUND

Application developers develop computer-executable software applications. In some examples, the application development process uses test data (also referred to as mock data) for testing an application (e.g., before the application is made available to customers. For example, for a business application, test data can include records for fake customers, accounts, orders, or any other business entities that make up an underlying application data model. The test data enables the developer to test the application software under various test scenarios, as well as to demonstrate the running application to various stakeholders.

In some examples, test data is created manually using an external tool (e.g., a spreadsheet program), and is uploaded to an application database. One challenge of creating test data is to manually create a reasonable amount of data that is meaningful from a business perspective, for example. This can be time and resource intensive. Another challenge is to manage the bits of data (often referred to as foreign keys) that define relationships between different entities. For example, and in a business context, if a set of order line items are all associated with a specific order header, then each of the line items has to hold an identifier, or a key, which is a link to order header. These keys are often length numbers of strings of characters, and creating the test data such that the keys are correct is very complex and time consuming.

### SUMMARY

Implementations of the present disclosure include computer-implemented methods for generating test data for an application that is to be tested. In some implementations, actions include receiving user input indicating an entity of the application, receiving a data structure of the entity, the data structure providing a set of elements of the entity, the set of elements including one or more elements, each element being associated with a value type, displaying the set of elements, each element being associated with a rule defining how values of the respective element are to be provided, and providing test data for elements of the set of elements based on respective rules, the test data including values that are semantically correct for a respective type. Other implementations of this aspect include corresponding systems, apparatus, and computer programs, configured to perform the actions of the methods, encoded on computer storage devices.

These and other implementations can each optionally include one or more of the following features: the value type of a respective element includes one of a string, an integer, a decimal, an association, a Boolean, a time, and a timestamp; the value type of a respective element includes a string, and the data structure defines a length of the string; a rule associated with a respective element indicates that the test data is randomly provided for the respective element; a rule associated with a respective element indicates that the test data for the respective element is provided based on user-defined constraints; and the user-defined constraints provide a fixed value for the respective element.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example high-level architecture in accordance with implementations of the present disclosure.

FIGS. 2A-2E depict example code fragments in accordance with implementations of the present disclosure.

FIG. 3 depicts an example process that can be executed in accordance with implementations of the present disclosure.

Like reference symbols in the various drawings indicate like elements.

### DETAILED DESCRIPTION

Implementations of the present disclosure are generally directed to automatically generating test data that is semantically correct. More particularly, implementations of the present disclosure enable test data to be generated either randomly, or based on user-defined constraints, which test data is semantically correct with respect to an entity, for which the test data is generated. In some implementations, one or more data structures of the application, for which the test data is to be provided, are used. In some examples, a data structure define an entity and includes one or more elements of the entity. In some examples, each element is associated with a respective data type (e.g., string, decimal, association). In some examples, if an element of an entity is based on a string value, the generated test data is of the type “string.” As another example, if an element of an entity is based on a decimal value, the generated test data is of the type “decimal.” In some examples, if an association is provided between entities, the generated test data includes a valid association. In some implementations, test data can be displayed as a preview. In some examples, a user can view the previewed test data before committing the test data to a database, for example.

Implementations of the present disclosure can be provided as part of an integrated development environment (IDE), discussed in further detail herein. In some examples, implementations of the present disclosure can be provided as one or more tools provided by an IDE.

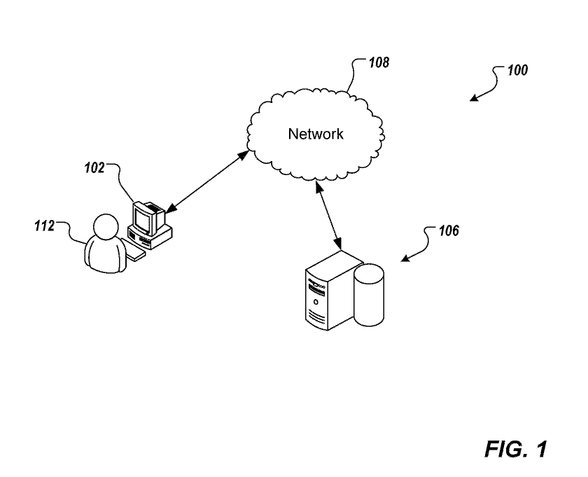

FIG. 1 depicts an example architecture 100 in accordance with implementations of the present disclosure. In the depicted example, the architecture 100 includes a client device 102 communicably connected to a back-end system 106 by a network 108. The client device 102 is operated by a user 112. In some examples, the client device 102 can be a computing device such as a laptop computer, a desktop computer, a smartphone, a personal digital assistant, a portable media player, a tablet computer, or any other appropriate computing device that can be used to communicate with the back-end system 106. In some examples, the back-end system 106 can include one or more computing devices such as a computer server. In some examples, the back-end system 106 can represent more than one computing device working together to perform the actions of a server computer (e.g., cloud computing). In some examples, the network 108 can be a public communication network (e.g., the Internet, cellular data network, dialup modems over a telephone network) or a private communications network (e.g., private LAN, leased lines). Although a single computing device 102 is depicted in FIG. 1, it is contemplated that multiple computing devices can be provided and can communicate with the back-end system 106 (e.g., through the network 108.

In accordance with implementations of the present disclosure, the back-end system 106 can host one or more applications. In some examples, the back-end system 106 can provide an IDE that users can access to create, edit and store source code. For example, the user 112 can use the computing device 102 to access the IDE over the network 108. In some examples, the IDE provides comprehensive facilities to developers for software development. Example IDEs can include a source code editor, build automation tools, a debugger, a compiler and/or an interpreter.

In some examples, source code can be provided in a particular programming language. An example programming language includes SAP River, provided by SAP AG of Walldorf, Germany. In general, SAP River (also referred to as the River Definition Language (RDL)) enables users (e.g., developers) to provide source code that describes an entity relationship model, associated behaviors, and other aspects for an application at a high level. More particularly, RDL enables users to provide source code for an application based on an underlying model (e.g., business model). In some examples, RDL enables users to capture the full model, including the structure of entities (e.g., elements of entities) and associations between entities, which are discussed in further detail herein. A compiler, such as an RDL compiler, processes the source code to provide suitable artifacts (e.g., tables) for implementing the application on an underlying platform.

In some examples, an application includes a respective application object that includes all types, entities, actions, views, roles, and other objects of the application therein. The application can be provided based on an underlying model (e.g., a business model). In some examples, action objects can be used to provide logic (e.g., business logic) to entities of the underlying application. For example, an action can take one or more parameters as input, and can return one or more values as output. In some examples, one or more namespaces can be provided, where namespaces enable the developer to group similar objects (e.g., entities or views) into logical sections. For example, namespaces can be used to organize the source code and to enable code fragments to be accessed (e.g., exposed to users for editing).

In some implementations, one or more data structures of the application, for which the test data is to be provided, are used. In some examples, a data structure defines an entity and includes one or more elements of the entity. In some examples, one or more entities can be provided for the application, each entity including one or more elements. For some example, an entity can be defined and can include one or more elements. In some examples, an entity (E) can be defined as:

E→e₁, . . . ,eₙ

where e is an element and n is an integer that is greater than 1.

In some examples, each element is associated with a respective data type (e.g., string, decimal, association). In some examples one element can be provided as a key element. In some examples, an entity can be associated with one or more other entities. For example, an element of an entity can include one or more other entities.

An example entity can be provided based on the following example code (listing):

Listing 1: Data Structure for Entity Flight

entity Flight {

| | |
|---|---|
| key flightId: | String(8); |

| | |
|---|---|
| flightNum: | String(3); |
| opened: | Boolean default false; |
| depCity: | Association to City; |
| arrCity: | Association to City; |
| depDate: | UTCTimestamp; |
| depTime: | LocalTime; |
| planeCode: | String(10); |
| seatList: | Association[0..*] to Seat via backlink |

flight
}

In this example, an entity “Flight” includes the elements “flightId,” “flightNum,” “opened,” “depCity,” “arrCity,” “depDate,” “depTime,” “planeCode,” and “seatlist,” where the element “flightId” is provided as the key. In some examples, each element can include a value, a type or an association. In the example provided above, the element “flightId” is of the type “string” of eight (8) characters in length, the element “flightNum” is of the type “string” of three (3) characters in length, the element “opened” is of the type Boolean (e.g., true or false) having a default value (e.g., false), the element “depCity” and the element “arrCity” are each associated with an entity “City,” the element “depDate” is associated with a value “UTCTimestamp,” the element “planeCode” is of the type “string” of ten (10) characters in length, and the element “seatList” is associated with an entity “Seat.”

Implementations of the present disclosure will be discussed in detail with reference to features of RDL, discussed above. It is appreciated, however, that any appropriate programming language can be used with implementations of the present disclosure.

As introduced above, implementations of the present disclosure are generally directed to automatically generating test data that is semantically correct. More particularly, implementations of the present disclosure enable test data to be generated either randomly, or based on user-defined constraints, which test data is semantically correct with respect to an entity, for which the test data is generated. In some implementations, one or more data structures of the application, for which the test data is to be provided, are used. In some examples, a data structure define an entity and includes one or more elements of the entity. In some examples, each element is associated with a respective data type (e.g., string, decimal, association). In some examples, if an element of an entity is based on a string value, the generated test data is of the type “string.” As another example, if an element of an entity is based on a decimal value, the generated test data is of the type “decimal.” In some examples, if an association is provided between entities, the generated test data includes a valid association. For example, and referring to the example code above, if every departure city (“depCity”) is associated with a “City” entity, the generated test data will provide a flight record, such that the association remains valid.

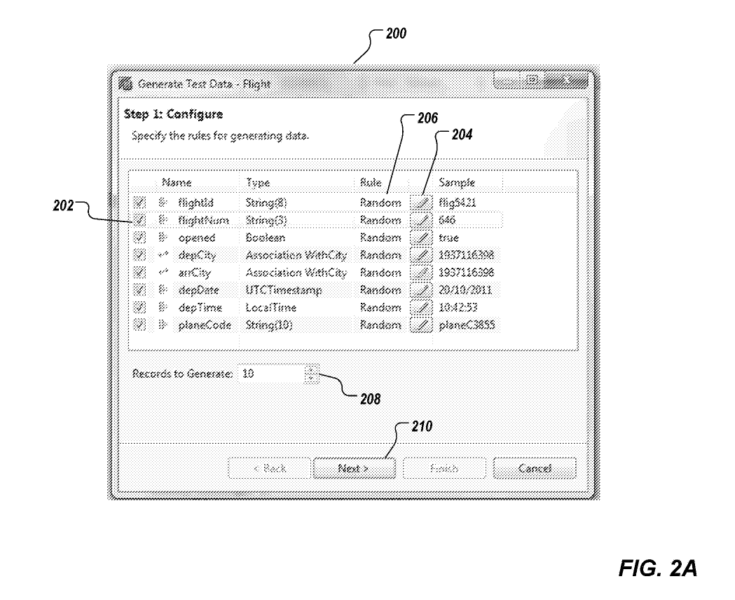

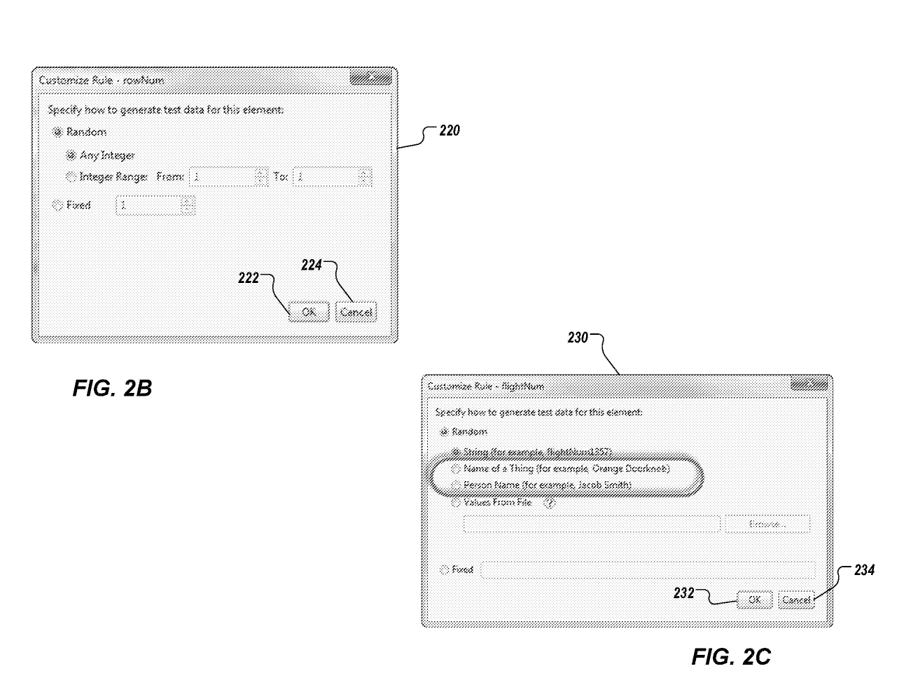

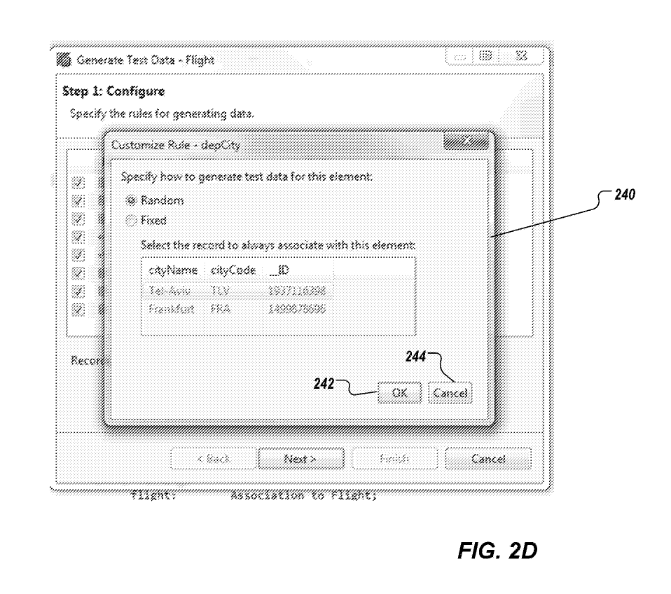

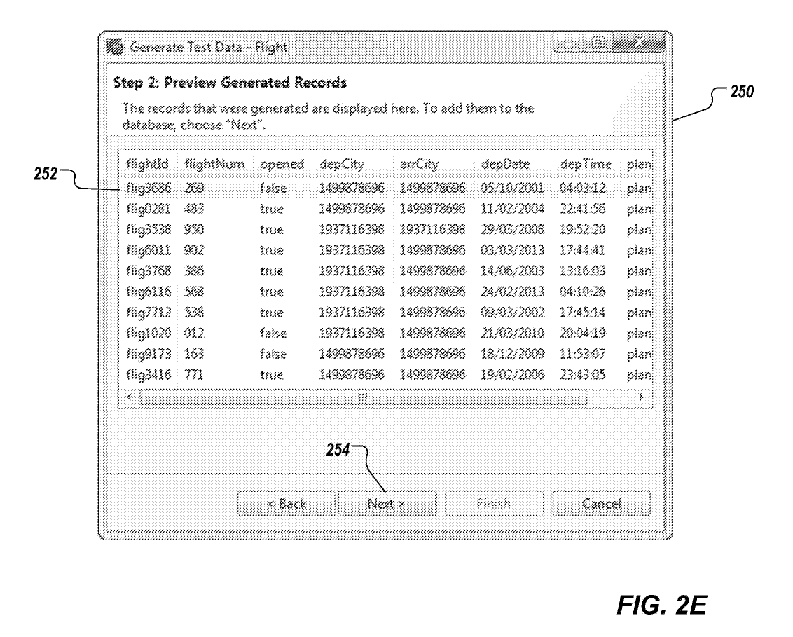

In some implementations, test data can include data records, each data record including a value for each element, for which test data is to be generated. In some examples, the underlying data structure of a particular entity is provided, and elements of the particular entity can be displayed to a user. In some examples, the user can select elements, for which test data is to be generated. In some examples, the test data can be randomly generated based on the type of values that are correct for the respective elements. In some examples, random generation can be provided as a default. In some examples, test data can be generated based on user-defined parameters. Example user parameters are discussed in further detail below with reference to FIGS. 2B through 2D. In some implementations, the user can indicate a number of data records that are to be generated for the entity. For example, if the user indicates that ten (10) data records are to be generated, ten (10) values can be generated for each element of the entity.

In some implementations, test data that has been generated can be displayed before committing the test data (e.g., storing the test data to a database). In some examples, a preview interface can be displayed to the user, the preview interface providing the generated test data for preview by the user. In some examples, and as discussed in further detail below, the user can commit the test data from the preview interface.

FIG. 2A depicts an example interface 200 for configuring rules that can be processed for generating test data in accordance with implementations of the present disclosure. In some examples, the interface 200 displays one or more elements of an entity that has been provided for an underlying application. For example, a user can select an entity, for which test data is to be generated, and the interface 200 can display one or more elements of the selected entity. That is, for example, the data structure of the selected entity can be retrieved (e.g., from computer-readable memory) and can be used to populate the interface 200.

In the example of FIG. 2A, the elements include elements described above with reference to the example entity “Flight.” For each element, the name and type are populated based on the underlying data structure (e.g., Listing 1 provided above). In some examples, the interface 200 includes respective selection elements 202 and rule editing elements 204 associated with respective elements. In some examples, a user can select elements, for which test data is to be automatically generated by interacting with (e.g., clicking on) the respective selection elements 202. In the depicted example, all of the elements have been selected. Consequently, test data will be automatically generated for each of the elements.

In the example of FIG. 2A, the rules for the respective elements indicate that the test data is to be randomly generated. For example, a rule indicator 206 is provided, which can indicate whether the test data for the respective element is to be randomly generated, or based on user-defined constraints. In some examples, the user can modify respective rules that are to be processed for generating test data for respective elements. For example, for a particular element, the user can select (e.g., click on) the respective rule edit element, and in response, a rule editing interface for the respective entity can be displayed. In some examples, the rule editing interface that is displayed is based on the type of the element (e.g., string, integer, decimal, Boolean, value, association).

In some examples, the interface 200 provides a record counter 208 that the user can interact with to define the number of records that are to be generated for the subject entity (e.g., “Flight”). For example, if the user indicates that ten (10) data records are to be generated, ten (10) values can be generated for each element of the subject entity. The example interface 200 also includes a “next” option 210. In some examples, after the user has selected the elements, for which test data is to be generated, and has modified any rules that are to be applied, the user can select (e.g., click on) the “next” option to preview the generated test data, as discussed in further detail herein with reference to FIG. 2E.

In some implementations, a rule editing interface is provided to enable the user to define a rule for generating the test data. In some examples, the content of the rule editing interface is provided based on the type of the respective element. For example, a first rule editing interface is provided for elements of the type integer, a second rule editing interface is provided for elements of the type decimal, and a third rule editing interface is provided for elements of the type string. In some examples, and as described by way of example below, the content (options) of the first rule editing interface, the second rule editing interface and the third rule editing interface is different from one another.

FIG. 2B depicts an example rule editing interface 220 that is provided for a respective element (e.g., rowNum (not shown in FIG. 2A)) that is of the type “integer.” For example, the rule editing interface 220 can be displayed in response to user selection of the rule editing element 204 associated with the subject element (e.g., rowNum). In the depicted example, the user is able to select whether the integers for the element are randomly selected or fixed. In some examples, if the user selects that the integers are to be randomly selected, the user can further select whether any integer can be selected, or define a range of integers, between which the integers can be randomly selected. In some examples, if the user selects that the integers are to have a fixed value, the user can select the fixed value. The user can confirm the rule by selecting the “OK” option 222, or cancel the edits by selecting the “Cancel” option 224.

FIG. 2C depicts an example rule editing interface 230 that is provided for a respective element (e.g., flightNum) that is of the type “string.” For example, the rule editing interface 230 can be displayed in response to user selection of the rule editing element 204 associated with the subject element (e.g., flightNum). In the depicted example, the user is able to select whether the strings for the element are randomly selected or fixed. In some examples, if the user selects that the strings are to be randomly selected, the user can further select whether any string can be randomly selected, a name of a thing (e.g., Orange Doorknob) can be randomly selected, a name of a person (e.g., Jacob Smith) can be randomly selected, or values can be randomly selected from an identified file. For example, if a name of a thing is selected, test data can be randomly selected from a set of nouns (e.g., pre-defined and stored in computer-readable memory). As another example, if a name of a person is selected, test data can be randomly selected from a set of names (e.g., pre-defined and stored in computer-readable memory). As another example, if values from file is selected, the user can identify the file, from which the values are to be randomly selected. For example, the file can be stored in computer-readable memory and can include a set of values. In some examples, if the user selects that the strings are to have a fixed value, the user can select the fixed value. The user can confirm the rule by selecting the “OK” option 232, or cancel the edits by selecting the “Cancel” option 234.

FIG. 2D depicts an example rule editing interface 240 that is provided for a respective element (e.g., depCity) that is of the type “association.” For example, the rule editing interface 240 can be displayed in response to user selection of the rule editing element 204 associated with the subject element (e.g., depCity). In the depicted example, the user is able to select whether the associations for the element are randomly selected or fixed. In some examples, a set of entities that can be associated with the subject element is provided. In the depicted example, the set of entities includes the entities “Tel-Aviv” and “Frankfurt,” and for each, respective elements “cityName,” “cityCode,” and unique identifier (ID) are provided. In some examples, if the user selects that the associations are to be randomly selected, an entity is randomly selected from the set of entities. In some examples, if the user selects that the associations are to be fixed, the user can select an entity from the set of entities (e.g., TelAviv, or Frankfurt for the entity “cityName”). The user can confirm the rule by selecting the “OK” option 242, or cancel the edits by selecting the “Cancel” option 244.

As noted above, after the user has indicated the elements, for which test data is to be generated, the number of records that are to be generated for the subject entity, and the rules that are to be applied for each element, the user can select the “Next” option 208 of the interface 200 of FIG. 2A to provide the test data. In response, a preview interface, such as the preview interface 250 of FIG. 2E can be displayed. In some examples, the preview interface displays records 252 that have been automatically generated for the respective entity (e.g., Flight). More particularly, test data has been generated for each element of the subject entity (e.g., Flight). In some examples, if the user is satisfied with the data records displayed in the interface 250, the user can select a “Next” option 254 to continue with the process and commit the test data to a database.

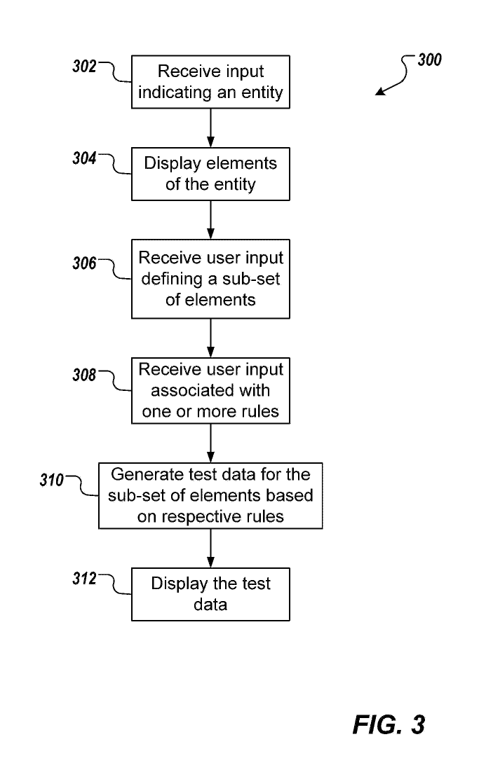

FIG. 3 depicts an example process 300 that can be executed in accordance with implementations of the present disclosure. The example process 300 can be implemented, for example, within the example architecture 100 of FIG. 1. In some examples, the example process 300 can be provided by one or more computer-executable programs executed using one or more computing devices.

Input indicating an entity is received (302). For example, a user can select an entity of a plurality of entities using an IDE. Elements of the entity are displayed (304). For example, elements of the entity selected by the user are displayed to the user (e.g., in the interface 200 of FIG. 2A). In some examples, a data structure underlying the entity is retrieved (e.g., from computer-readable memory) and defines the elements that are to be displayed. User input defining a sub-set of elements is received (306). For example, the user can select one or more elements of a set of elements to provide the sub-set of elements, for which test data is to be generated (e.g., using respective selection elements 202 of the interface 200 of FIG. 2A). In some examples, the sub-set of elements includes all elements displayed (e.g., all elements of the set of elements). In some examples, the sub-set of elements includes less than all elements displayed (e.g., less than all elements of the set of elements). User input associated with one or more rules is received (308). For example, the user can edit one or more rules for providing test data (e.g., as discussed above with reference to FIGS. 2B-2D). In some examples, the user can leave one or more rules set to respective defaults (e.g., random). Test data is provided for each element of the sub-set of elements based on respective rules (310). As discussed herein, the test data is provided such that it is semantically correct for types of the respective elements. The test data is displayed (312). In some examples, the test data is stored to a database. For example, the test data can be stored in a computer-readable/-writable table (file) in the database.

In some implementations, an application is executed based on the test data. That is, for example, the application accesses the test data (e.g., from the table stored in the database) and processes the test data based on functionality provided by the application. In some examples, the application provides output (e.g., displayed on a display) based on the test data.

Implementations of the present disclosure enable the efficient provision of test data for computer-executable applications. For example, implementations of the present disclosure reduce the manual labor that may otherwise be required to provide test data. That is, for example, instead of manually typing in values and checking each value for semantic correctness, semantically correct values are automatically provided. Further, implementations of the present disclosure reduce computational resources (e.g., processors and/or memory) that would otherwise be required to provide test data. For example, implementations of the present disclosure alleviate the need of an external tool (e.g., a spreadsheet program) to provide test data. In this manner, resources (e.g., processors, memory) that would be required to execute such a tool.

Implementations of the present disclosure further enhance the usability of the provided test data. For example, because implementations of the present disclosure provide semantically correct test data, the application can be executed using the test data, while avoiding errors that may otherwise occur as a result of semantically incorrect test data. As another example, if the underlying data structure of an entity changes (e.g., an element is added or removed from the entity), new test data can be quickly and automatically provided (e.g., for the entire entity, or just for the newly added element). Further, implementations of the present disclosure maintain the integrity of associations between entities, avoiding errors that may otherwise occur as a result of manually curating test data.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for providing test data for an application that is to be tested, the method being executed using one or more processors and comprising:
receiving, by the one or more processors, user input indicating an entity of the application;
receiving, by the one or more processors, a data structure of the entity, the data structure providing a set of elements of the entity, the set of elements comprising one or more elements, each element being associated with a value type;
displaying, by the one or more processors, the set of elements, each element being associated with a rule defining how values of the respective element are to be provided; and
providing, by the one or more processors, test data for elements of the set of elements based on respective rules, the test data comprising values that are semantically correct for a respective type.

2. The method of claim 1, wherein the data structure provides a name and a respective value type for each element in the set of elements.

3. The method of claim 1, wherein the value type of a respective element comprises one of a string, an integer, a decimal, an association, a Boolean, a time, and a timestamp.

4. The method of claim 1, wherein the value type of a respective element comprises a string, and the data structure defines a length of the string.

5. The method of claim 1, wherein a rule associated with a respective element indicates that the test data is randomly provided for the respective element.

6. The method of claim 1, wherein a rule associated with a respective element indicates that the test data for the respective element is provided based on user-defined constraints.

7. The method of claim 6, wherein the user-defined constraints provide a fixed value for the respective element.

8. A non-transitory computer-readable storage medium coupled to one or more processors and having instructions stored thereon which, when executed by the one or more processors, cause the one or more processors to perform operations for generating test data for an application that is to be tested, the operations comprising:
receiving user input indicating an entity of the application;
receiving a data structure of the entity, the data structure providing a set of elements of the entity, the set of elements comprising one or more elements, each element being associated with a value type;
displaying the set of elements, each element being associated with a rule defining how values of the respective element are to be provided; and
providing test data for elements of the set of elements based on respective rules, the test data comprising values that are semantically correct for a respective type.

9. The computer-readable storage medium of claim 8, wherein the data structure provides a name and a respective value type for each element in the set of elements.

10. The computer-readable storage medium of claim 8, wherein the value type of a respective element comprises one of a string, an integer, a decimal, an association, a Boolean, a time, and a timestamp.

11. The computer-readable storage medium of claim 8, wherein the value type of a respective element comprises a string, and the data structure defines a length of the string.

12. The computer-readable storage medium of claim 8, wherein a rule associated with a respective element indicates that the test data is randomly provided for the respective element.

13. The computer-readable storage medium of claim 8, wherein a rule associated with a respective element indicates that the test data for the respective element is provided based on user-defined constraints.

14. The computer-readable storage medium of claim 13, wherein the user-defined constraints provide a fixed value for the respective element.

15. A system, comprising:
a computing device; and
a computer-readable storage device coupled to the computing device and having instructions stored thereon which, when executed by the computing device, cause the computing device to perform operations for generating test data for an application that is to be tested, the operations comprising:
receiving user input indicating an entity of the application;
receiving a data structure of the entity, the data structure providing a set of elements of the entity, the set of elements comprising one or more elements, each element being associated with a value type;
displaying the set of elements, each element being associated with a rule defining how values of the respective element are to be provided; and
providing test data for elements of the set of elements based on respective rules, the test data comprising values that are semantically correct for a respective type.

16. The system of claim 15, wherein the data structure provides a name and a respective value type for each element in the set of elements.

17. The system of claim 15, wherein the value type of a respective element comprises one of a string, an integer, a decimal, an association, a Boolean, a time, and a timestamp.

18. The system of claim 15, wherein the value type of a respective element comprises a string, and the data structure defines a length of the string.

19. The system of claim 15, wherein a rule associated with a respective element indicates that the test data is randomly provided for the respective element.

20. The system of claim 15, wherein a rule associated with a respective element indicates that the test data for the respective element is provided based on user-defined constraints.
